(19) United States
(12) Patent Application Publication
(10) Pub. No.: US 2020/0094625 A1
(43) Pub. Date: Mar. 26, 2020

(54) ADJUSTABLE AIRLESS TIRE WITH AN AIR SAC WITHIN A WHEEL

(71) Applicants: Hai Huang, (US); Tony Huang, (US)

(72) Inventors: Hai Huang, Herndon, VA (US); Tony Huang, Herndon, VA (US)

(73) Assignees: Hai Huang, Herndon, VA (US); Tony Huang, Herndon, VA (US)

(21) Appl. No.: 16/416,069

(22) Filed: May 17, 2019

Related U.S. Application Data
(63) Continuation-in-part of application No. 16/137,436, filed on Sep. 20, 2018.
Application No. 16/137,436 is a continuation-in-part of application No. 16/183,681, filed on Nov. 7, 2018.

(51) Int. Cl. B60C 7/12; B60B 9/18; B60B 1/06

(52) U.S. Cl. CPC B60C 7/12; B60B 1/06; B60B 9/18

(57) ABSTRACT

An adjustable airless tire with an air sac within a wheel includes an air sac located within a wheel to transfer a load of a vehicle from a ground contacting area of a tire to whole walls of the tire through a plurality of spoke structure of rods that connect with the walls of the air sac and the tire. A sensor detects a tension of the tire and a variation of a tension during driving. A control component adjusts the tension of the tire according the load of the vehicle and road conditions to improve its fuel efficiency, comfortability, controllability and safety. A rim of the wheel keeps an appropriate distance from the tire to limit the maximal level of upward movement of the rods. A transversely curved tire mounted to the rim of the wheel to form closed space between the tire and the wheel.

### CROSS-REFERENCES TO RELATED APPLICATIONS

This application claims priority to U.S. patent application Ser. No. 16/137,436 filed on Sep. 20, 2018 and U.S. patent application Ser. No. 16/183,681 filed on Nov. 7, 2018, the entire contents of all of which are incorporated herein by reference.

### FIELD OF THE DISCLOSURE

The present disclosure generally relates to the field of an adjustable airless tire with an air sac within a wheel and, more particularly, relates to a system of the adjustable airless tire with a plurality of spoke structure of the rods connecting with a wall of the tire and an air sac within a wheel, which imitates a mechanism of an internal inflated tire. At same time, a sensor and a control component are also set up to detect and regulate a tension of the tire according road conditions, which possess its advantages of fuel economy, comfortability, controllability and safety.

### BACKGROUND

Current internal inflated tires provide high suspension capabilities for a vehicle by transferring a load of the vehicle from a ground contact area of a tire to whole walls of the tires through air within the tires, which produces a tension to the walls of the tires. the elasticity of the tire decides a suspension of the tire for the vehicle. But, the biggest disadvantage for the internal inflated tires is air leaking if the tires are penetrated by a sharp material.

Nowadays, there are several types of airless tires. But, they cannot transfer the vehicle load from the ground contact area to whole walls of the tires, and just provides limited buffering for the vehicle from the ground contact area of the tires. In addition, they need special materials that must have enough hardness to support the heavy load of the vehicle as well as enough elastic ability to provide suspension for the vehicle. These contradictory requirements compromise their individual function. Its materials are expensive, and its structures also limit the highest speed it can reach.

Road conditions may be different, such as a rough road or slippery one, which need different tension of the tire to keep comfortability, stability and safety during driving. But, current tires cannot adjust the tension of the tire according changes of the load of the vehicle or the road conditions.

The invention designs an adjustable tire with a plurality of spoke structure of rods connecting with whole wall of the tire and an air sac within a wheel to transfer a load of a vehicle from a ground contact area of the tire to whole walls of the tires, which imitates the internal inflated tires to provide good suspension for the vehicle. At the same time, a sensor and a control component are set up to detect and regulate a tension of the tire according to the conditions of a road. The adjustable airless tire system in the invention improves fuel efficiency, comfortability, controllability and safety.

### BRIEF SUMMARY OF THE DISCLOSURE

Instead of placing an inner tube within a tire as current internal inflated tire, which suffer a risk of air leaking if the tire is penetrated with a sharp material, the present disclosure includes placing an air sac within a wheel to transfer a load of a vehicle from a ground contact area of the tire to whole walls of the tire through a plurality of spoke structure of rods, which imitates a mechanism of an internal inflated tire to provide good suspension.

At the same time, by detecting a tension of the tire with a sensor, a control component will regulate an air pressure of the sac to control the tension of the tire. As the result, a size of the ground contact area of the tire will change according to road situations, which improve its fuel efficiency, comfortability, controllability and safety during driving.

Utilizing any suitable elastomer and all types of reinforcing materials as similar as the internal inflated tire, the tire is cost effectiveness and affordable. Its curved shape provides a closed space between a rim of a wheel and the tire to prevent foreign objects sticking between them.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a view schematically showing an adjustable airless tire with an air sac within a wheel related to the present invention.

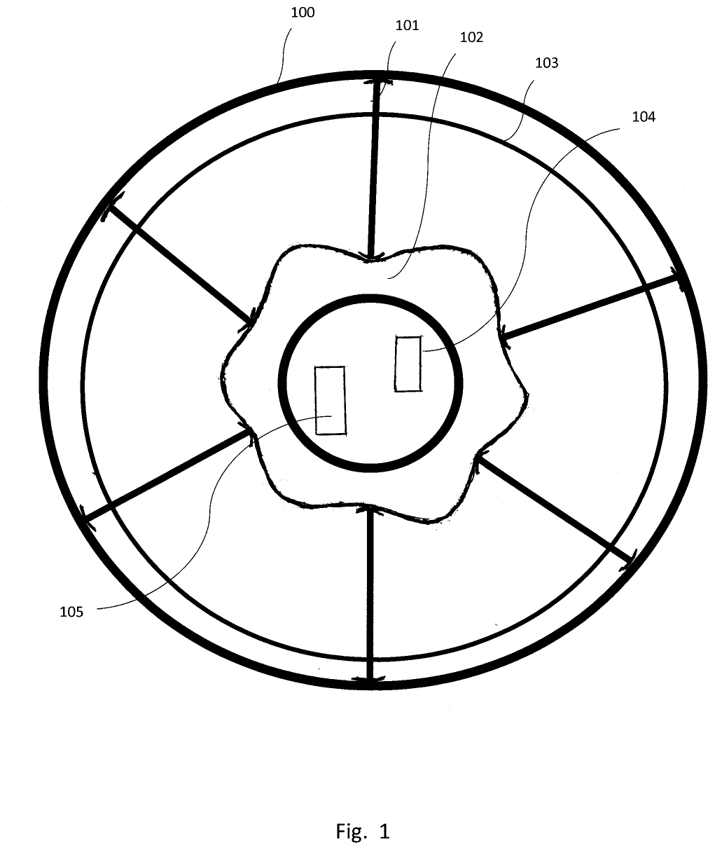

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

Current internal inflated tire contains an inner tube within the tire, which suffer a risk of air leaking if the tire is penetrated with a sharp material. In the invention, an air sac 102 is placed within a wheel, which supports whole walls of a tire 100 through a plurality of spoke structure of rods 101. As a result, a load of a vehicle is transferred from a ground contact area of the tire to whole walls of the tire, which imitates a mechanism of an internal inflated tire to provide good suspension for the vehicle.

the air sac is located within the wheel with appropriate support and protection around it. The air sac is made up of rubber that is similar to a inner tube of the internal inflated tire. its exterior layer is appropriately enhanced to limit its extension. The air sac transfers the load of the vehicle from a ground contact area of the tire to whole walls of the tire through a plurality of spoke structure of the rods.

The rods are made up of appropriate metallic or non-metallic materials that are strong enough to support the load of the vehicle. A curved plate is fixed to both tops of rods that contacting with the walls of the tire and the air sac. As the ground contact area of the tire compress the corresponding loaded rods, which press the air sac and increase its air pressure. As a result, increased pressure of the air sac compress other rods moving upward to compress other parts of the walls of the tires. By this way, the load of the vehicle is transferred from the ground contact area of the tire to whole walls of the tire through the air sac, which imitates the mechanism of an internal inflated tire to provide good suspension.

A sensor 104 and a control component 105 are installed around the air sac. The sensor will detect the air pressure in the air sac to calculate the tension of the tire and the load of the vehicle, and will give alert if the tire is close to overloaded. It also detects a variation of the air pressure during driving to judge road condition. An increased variation of the air pressure during driving suggests a rougher condition of the road.

The control component can regulate the air pressure of the air sac to regulate the tension of the tire through the rods. Regulating the tension of the tire will improve fuel efficiency, comfortability, controllability and safety during driving. First, according the load of the vehicle to regulate the tension of the tire can optimize a size of the ground contact area of the tire with the road, which will reduce rolling resistance and improves fuel efficiency; Second, driving on the rough road, severe shaking of the tire will increase the variation of the air pressure. Reducing the tension of the tire with the control component will reduce riding vibration and create a softer ride to improve the comfortability; Third, driving on a slippery road condition, such as raining or snowing, decreasing the tension of the tire will increase the size of the ground contact area of the tire with the road, which improves the controllability and safety of the vehicle during driving; Fourth, driving on sand or mud terrain, increasing the size of the ground contact area of the tire will decrease pressure of the tire on the ground, which reduces sinking of the tire into sand or mud. It also improves traction of the tire over loose surfaces. Fifth, at emergency situation, the increased size of the ground contact area of the tire will increase frictional resistance between the ground and the tire, which decreases braking distance.

A steel rim 103 of the wheel keeps appropriate distance from the tire to limit the maximal level of upward movement of the rods, and support the load of the vehicle if the tire is overload or the rods lose their function.

The tire is made of any suitable elastomers with all types of reinforcing materials that may be similar as the internal inflated tire to help support the load of the vehicle and enhance its performance. A transverse shape of the tire is curved with its bead of the tire fixed to the flanges of the rim of the wheel, which is similar to the internal inflated tires to form closed space between the tire and the wheel. It prevents foreign objects, such as stones, from sticking between the tire and the wheel during driving as well as transfers a rotating force between the wheel and tire.

Other applications, advantages, alternations, modifications, or equivalents to the disclosed embodiments are obvious to those skilled in the art and are intended to be encompassed within the scope of the present disclosure.

What is claimed is:

1. An adjustable airless tire with an air sac within a wheel comprising:
an air sac located within a wheel;
a plurality of spoke structure of rods connecting between walls of the air sac and walls of a tire;
a sensor located around the air sac;
a control component located around the air sac; and
the transversely curved tire mounted to a rim of the wheel.

2. The adjustable airless tire according to claim 1, wherein the rods are made up of metallic or non-metallic materials that are strong enough to support a load of the vehicle, and comprise curved plates at both ends, which are shaped for attachment to the walls of the tire and the walls of the air sac.

3. The adjustable airless tire according to claim 1, wherein the air sac is made from rubber with appropriate enhancement at its exterior layer to limit its extension, and the air sac is appropriately supported and protected within the wheel.

4. The adjustable airless tire according to claim 1, wherein a plurality of spoke structure of the rods connecting between the walls of the air sac and the walls of the tire, which transfers pressure from the loaded rods to other rods, and distributes the load of the vehicle from the ground contact area of the tire to whole walls of the tire.

5. The adjustable airless tire according to claim 1, wherein the sensor detects a tension of the tire to calculate the load of the vehicle, and a variation of the tension of the tire during driving to estimate roughness of a road.

6. The adjustable airless tire according to claim 1, wherein the control component regulates a pressure of the air sac, which affects the tension of the tire and the ground contacting area of the tire.

7. The adjustable airless tire according to claim 1, wherein a rim of the wheel keeps an appropriate distance from the tire to limit the maximal level of upward movement of the rods, and supports the load of the vehicle if the tire is overloaded or the rods lose their function.

8. The adjustable airless tire according to claim 1, wherein the tire is made of elastomers with all types of reinforcing materials, and is formed as transversely curved shape with its bead of the tire fixed to the flanges of the rim of the wheel, which makes a closed space between the tire and the rim of the wheel.
